(19) United States
(12) Patent Application Publication
(10) Pub. No.: US 2021/0046971 A1
(43) Pub. Date: Feb. 18, 2021

(54) VEHICLE AND CONTROLLING METHOD THEREOF

(71) Applicants: Hyundai Motor Company, Seoul (KR); Kia Motors Corporation

(72) Inventors: JungHyeon Bae, Yongin (KR); Taehoon Kim, Seoul (KR)

(73) Assignees: Hyundai Motor Company, Seoul (KR); Kia Motors Corporation, Seoul (KR)

(21) Appl. No.: 16/808,959

(22) Filed: Mar. 4, 2020

(30) Foreign Application Priority Data
Aug. 16, 2019 (KR) 10-2019-0100081

(51) Int. Cl. B62D 5/04; B62D 15/02; G05D 1/02; H02J 7/16; H02P 9/14

(52) U.S. Cl. CPC B62D 5/046; B62D 15/021; H02P 9/14; G05D 1/0212; H02J 7/16; B62D 15/027

(57) ABSTRACT

A vehicle capable of supplying power to an electrical device reliably is provided. The vehicle includes an electric steering device that changes a driving direction of the vehicle, a battery that supplies power to the electric steering device, and a generator that supplies power to at least one of the electric steering device and the battery. A controller determines at least one of a steering angle and a steering angle speed of the electric steering device based on the driving path of the vehicle, and adjust the generated power of the generator before operating the electric steering device based on at least one of the steering angle and the steering angle speed.

### CROSS-REFERENCE TO RELATED APPLICATION(S)

This application is based on and claims priority under 35 U.S.C. § 119 to Korean Patent Application No. 10-2019-0100081, filed on Aug. 16, 2019, the disclosure of which is incorporated by reference in its entirety.

### BACKGROUND

### 1. Technical Field

The present disclosure relates to a vehicle and a controlling method thereof, and more particularly, to a vehicle and a controlling method that secure power supply stability of a vehicle.

### 2. Description of the Related Art

In general, a vehicle s a transportation means that travels on a road or a line using fossil fuels, electricity, or the like as a power source. For example, the vehicle may be driven using the power generated from the engine. The vehicle includes various electrical devices to protect the driver and provide the driver with comfort. The vehicle also includes a battery for powering the electrical devices and a generator that powers electrical devices and charges the battery.

Some of the electrical devices consume a lot of power for a short period of time. For example, a motor provided in the electric steering apparatus may consume a substantial amount of power for a short period of time. Accordingly, when the electrical device consumes a substantial amount of power for a short period of time, the charge rate (or charge amount) of the battery may be drastically reduced, and the output voltage of the battery may be drastically reduced. As a result, the voltage applied to the electrical devices is reduced, and the voltage decrease may cause malfunction of the electrical devices or reset of the electrical devices.

### SUMMARY

In view of the above, an aspect of the present disclosure provides a vehicle and a control method thereof capable of permitting temporary driving of a temporary driver for a short period of time. For the above reasons, one aspect of the present disclosure ensure the power supply stability of the vehicle.

One aspect of the present disclosure provides a vehicle capable of stably supplying electric power to an electrical device and a controlling method thereof. Another aspect of the present disclosure provides a vehicle capable of estimating power consumption of electrical devices during parking and a control method thereof. Yet another aspect of the present disclosure provides a vehicle and a control method thereof capable of controlling the amount of power generated by the generator based on the expected power consumption during parking.

In accordance with an aspect of the present disclosure, a vehicle may include an electric steering device configured to change a driving direction of the vehicle; a battery configured to supply power to the electric steering device; a generator configured to supply power to at least one of the electric steering device and the battery; and a controller configured to determine at least one of a steering angle and a steering angle speed of the electric steering device based on the driving path of the vehicle, and adjust the generated power of the generator before operating the electric steering device based on at least one of the steering angle and the steering angle speed.

The controller may be configured to increase the generated power of the generator before operating the electric steering device when the steering angle is greater than a predetermined angle or the steering angle speed is greater than a predetermined angular speed. The controller may also be configured to decrease the generated power of the generator before terminating the operation of the electric steering device and adjust the generated power of the generator before operating the electric steering device based on at least one of an available power of the vehicle and a charge rate of the battery.

Additionally, the controller may be configured increase the generated power of the generator before operating the electric steering device when the available power of the vehicle is less than a reference power or the chare rate of the battery is less than a reference charge rate. The controller may be configured to adjust the generated power of the generator before operating the electric steering device based on a friction coefficient of a road on which the vehicle travels. The controller may also be configured to increase the generated power of the generator before operating the electric steering device when the friction coefficient is greater than a reference value.

The controller may be configured to correct the driving path when the steering angle is greater than a reference angle or the steering angular speed is greater than the a reference angle speed. The controller may also be configured to correct the driving path such that the steering angle is less than the reference angle or the steering angle speed is less than the reference angular speed. In addition, the controller may be configured to generate a parking path to park the vehicle, determine at least one of the steering angle or the steering angle speed of the electric steering device, and adjust the generated power of the generator based on at least one of the steering angle or the steering angle speed.

In accordance with an aspect of the present disclosure, a method for controlling a vehicle having an electric steering device, a battery and a generator may include determining a driving path of the vehicle; determining a steering angle and a steering angle speed of the electric steering device based on the driving path; and adjusting a generated power of the generator before operating the electric steering device based on at least one of the steering angle and the steering angle speed.

Adjusting the generated power of the generator may include increasing the generated power of the generator before operating the electric steering device when the steering angle is greater than a predetermined angle or the steering angle speed is greater than a predetermined angular speed. Additionally, adjusting the generated power of the generator may include decreasing the generated power of the generator before terminating the operation of the electric steering device.

The method may further include adjusting the generated power of the generator before operating the electric steering device based on at least one of an available power of the vehicle and a charge rate of the battery. Adjusting the generated power of the generator based on at least one of the available power of the vehicle and the charge rate of the battery may include increasing the generated power of the generator before operating the electric steering device when the available power of the vehicle is less than a reference power or the chare rate of the battery is less than a reference charge rate.

The method may further include adjusting the generated power of the generator before operating the electric steering device based on a friction coefficient of a road on which the vehicle travels. Adjusting the generated power of the generator based on the friction coefficient of the road may include increasing the generated power of the generator before operating the electric steering device when the friction coefficient is greater than a reference value.

The method may further include correcting the driving path when the steering angle is greater than a reference angle or the steering angular speed is greater than the reference angle speed. Correcting the driving path may include correcting the driving path such that the steering angle is less than the reference angle or the steering angle speed is less than the reference angular speed. The method may further include generating a parking path to park the vehicle, determining at least one of the steering angle or the steering angle speed of the electric steering device, and adjusting the generated power of the generator based on at least one of the steering angle or the steering angle speed.

### BRIEF DESCRIPTION OF THE DRAWINGS

These and/or other aspects of the disclosure will become apparent and more readily appreciated from the following description of the exemplary embodiments, taken in conjunction with the accompanying drawings of which:

FIG. 1 illustrates electrical devices of a vehicle according to an exemplary embodiment;

FIG. 2 illustrates a control configuration of a vehicle according to an exemplary embodiment;

FIG. 3 illustrates an example of a parking path of a vehicle, according to an exemplary embodiment;

FIG. 4 illustrates a power state while a vehicle according to an exemplary embodiment is driving along a parking path shown in FIG. 3;

FIG. 5 illustrates power generation control according to a steering angle and a steering angle speed of a vehicle according to an exemplary embodiment;

FIG. 6 illustrates an example of calculating operating power of a vehicle, according to an exemplary embodiment;

FIG. 7 is a view illustrating generation control according to a battery charging rate and operating power of a vehicle according to an exemplary embodiment;

FIG. 8 is a diagram illustrating generation control of a vehicle according to an exemplary embodiment;

FIG. 9 illustrates a power state by power generation control of a vehicle according to an exemplary embodiment; and

FIG. 10 illustrates a parking path optimization of a vehicle according to an exemplary embodiment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Reference will now be made in detail to the exemplary embodiments of the present disclosure, examples of which are illustrated in the accompanying drawings, wherein like reference numerals refer to like elements throughout. This specification does not describe all elements of the exemplary embodiments of the present disclosure and detailed descriptions on what are well known in the art or redundant descriptions on substantially the same configurations may be omitted.

Throughout the specification, when an element is referred to as being “connected to” another element, it may be directly or indirectly connected to the other element and the “indirectly connected to” includes being connected to the other element via a wireless communication network. Throughout the specification, when a member is located “on” another member, this includes not only when one member is in contact with another member but also when another member is present between the two members. The terms first, second, etc. are used to distinguish one component from another component, and the component is not limited by the terms described above. An expression used in the singular encompasses the expression of the plural, unless it has a clearly different meaning in the context. The reference numerals used in operations are used for descriptive convenience and are not intended to describe the order of operations and the operations may be performed in a different order unless otherwise stated.

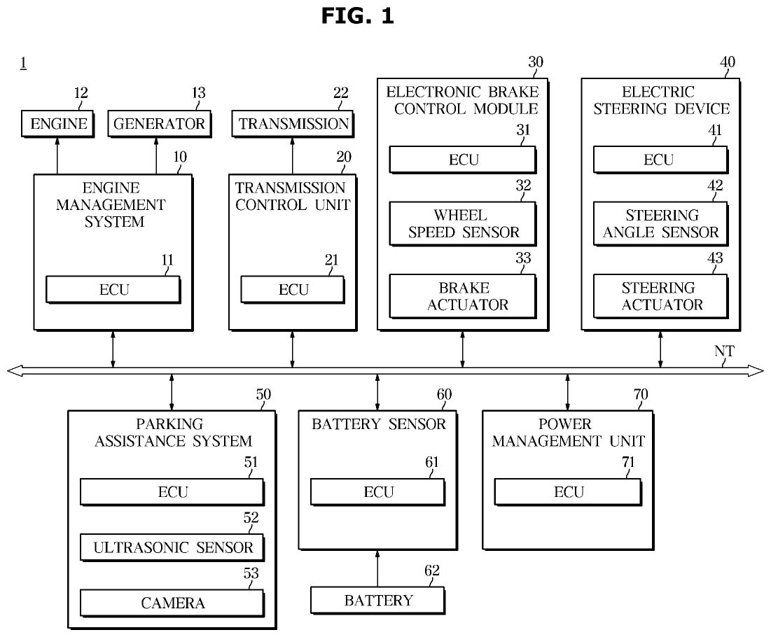

Hereinafter, exemplary embodiments of the present disclosure will be described in detail with reference to the accompanying drawings. FIG. 1 illustrates electrical devices of a vehicle according to an exemplary embodiment. The vehicle 1 includes a body which forms an exterior thereof and houses a driver and/or luggage, chassis including the components of the vehicle 1 other than the vehicle body, and electrical loads that protect the driver and provide convenience to the driver. For example, the electrical loads as shown in FIG. 1 may include an engine management system (EMS) 10, a transmission control unit (TCU) 20, an electronic brake control module (EBCM) 30, a Motor-Driven Power Steering (MDPS) 40, a Parking Assist System (PAS) 50, a Battery Sensor 60, and a Power Management Unit (power management unit) (70). The various units and components may be operated by a controller.

The engine management system 10 may be configured to operate the engine 12 and manage the engine 12 in response to the driver's acceleration command through the accelerator pedal. For example, the engine management system 10 may be configured to perform engine torque control, fuel economy control, and/or engine failure diagnosis. In addition, the engine management system 10 may be configured to operate the generator 13. The engine management system 10 may include an electronic control unit (hereinafter referred to as “ECU”) 11 configured to operate data for operating the engine 12 and the generator 13.

The transmission control unit 20 or transmission controller may be configured to operate the transmission in response to a shift command input through the shift lever or the traveling speed of the vehicle 1. For example, the transmission controller 20 may be configured to perform clutch control, shift control, and/or engine torque control during shifting. The transmission controller 20 may include an ECU 21 configured to process data for transmission control. The electronic brake control module 30 may be configured to operate the braking device of the vehicle 1 in response to the braking command of the driver through the brake pedal, and maintain the balance of the vehicle 1. For example, the electronic brake control module 30 may be configured to perform automatic parking brake, slip prevention during braking, slip prevention during steering, and or vehicle attitude control. The electronic brake control module 30 may include a wheel speed sensor 32 configured to measure wheel speed to detect wheel slip, a brake actuator 33 configured to generate hydraulic pressure for stopping the rotation of the wheel, and an ECU 31 configured to process data for operating the braking device.

The electric steering device 40 may assist the driver to operate the steering wheel more easily. For example, the electric steering apparatus 14 may assist the driver's steering operation by reducing the steering force when driving at low speed or parking, and increasing the steering force when driving at high speed. The electric steering device 40 may include a steering angle sensor 42 configured to measure the steering angle by the driver steering operation, a steering actuator 43 configured to generate a driving force for changing the direction of the wheel, and an ECU 41 configured to process data for assisting the driver's steering operation. The parking assistance system 50 may be configured to search for a parking space to park the vehicle 1 and generate a parking path for parking the vehicle 1 in the parking space. The parking assistance system 50 also allows the vehicle 1 to travel along the parking path by operating the engine management system 10, the transmission control unit 20, the electronic brake control module 30 and the electric steering device 40. The parking assistance system 50 may include an ultrasonic sensor 52 and a camera 53 for searching for a parking space to park the vehicle 1 and detecting an obstacle, and an ECU 51 configured to process data for generating a parking path.

The battery sensor 60 may be configured to detect a charge rate of the battery 62 that stores electrical energy. For example, the battery sensor 60 may include sensors configured to measure the output voltage of the battery 62, the output current of the battery 62, the temperature of the battery 62, and the like, and ECU 61 configured to determine the charge rate of the battery 62 based on the output voltage, the output current and the temperature. The power management unit 70 may be configured to distribute power to the electrical devices of the vehicle 1 and operate the electrical devices mounted within the vehicle 1.

For example, the power management unit 70 may be configured to monitor the power state of the vehicle 1 based on the amount of power generated by the generator 13 and the charge rate of the battery 62, and execute the power generation operation of the generator 13 based on the power state of the vehicle 1. The power management unit 70 may include an ECU 71 configured to process data for adjusting the power generation operation of the generator 13. These electrical devices may communicate with each other via the vehicle communication network NT. For example, electrical loads may load data and receive data over Ethernet, Most Oriented Systems Transport (MOST), Flexray, CAN (Controller Area Network), LIN (LIN) and Local Interconnect Network (LIN).

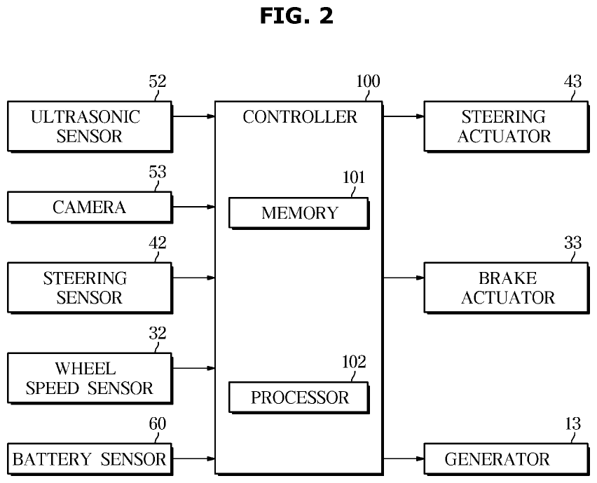

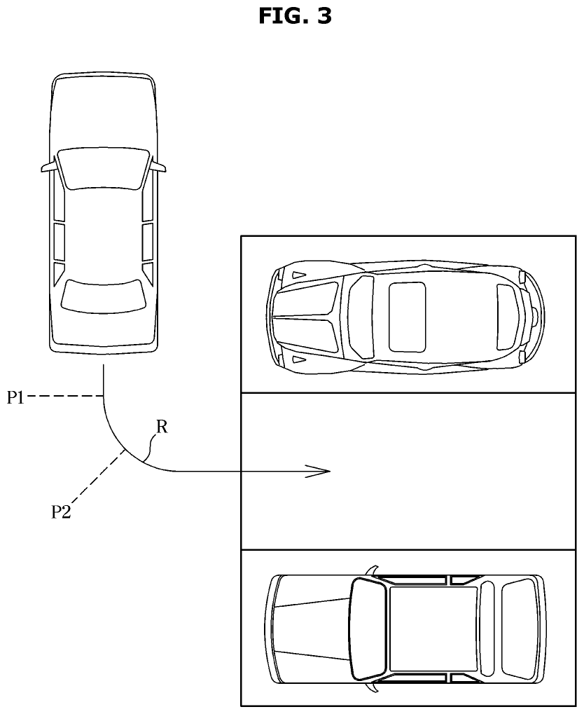

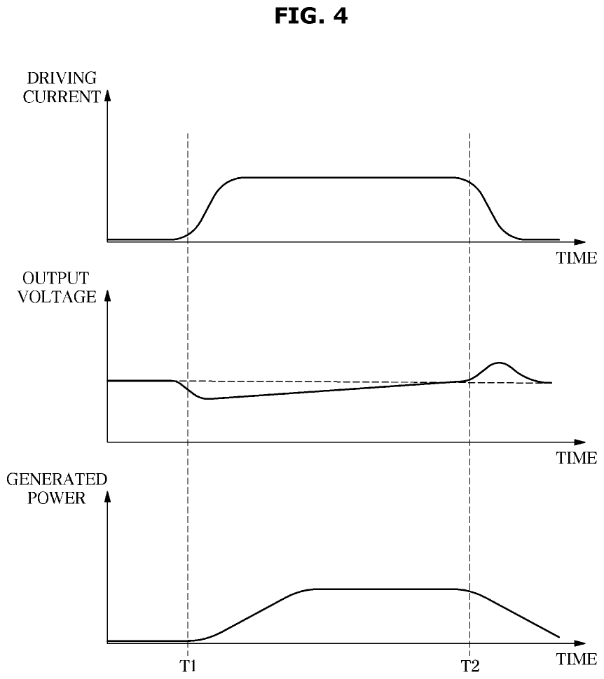

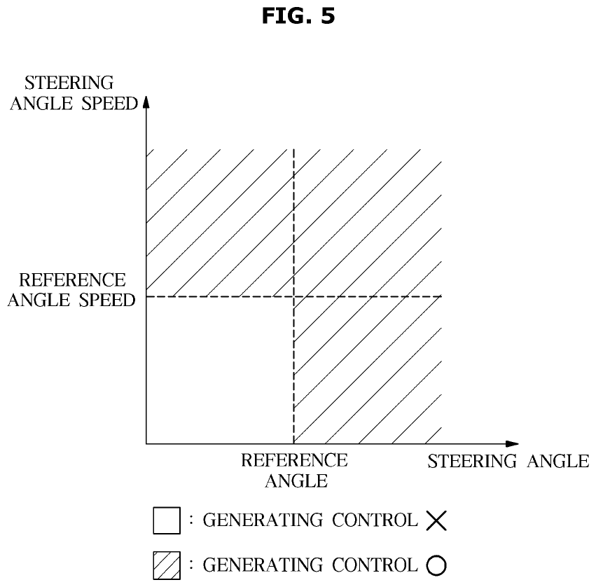

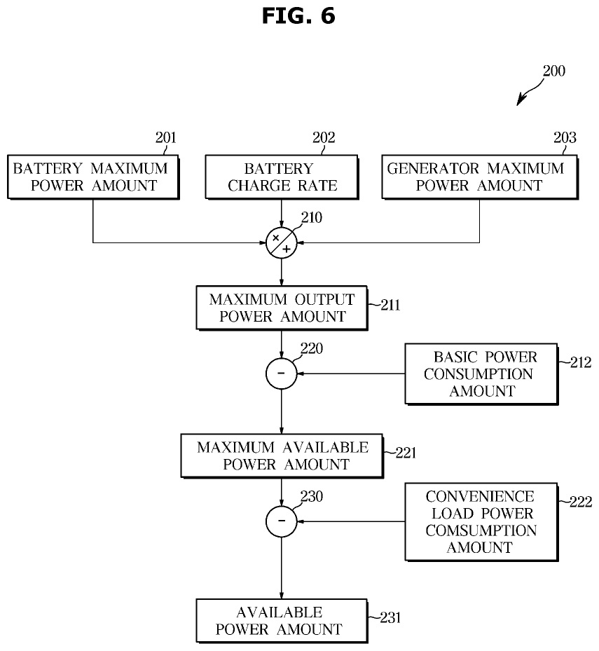

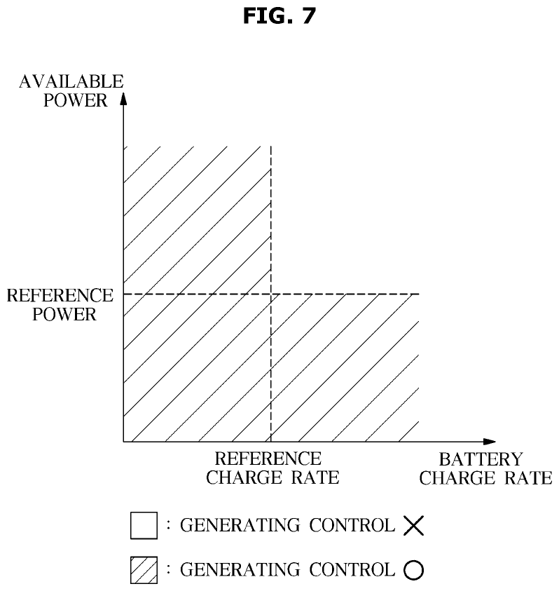

FIG. 2 illustrates a control configuration of a vehicle according to an exemplary embodiment. FIG. 3 illustrates an example of a parking path of a vehicle, according to an exemplary embodiment. FIG. 4 illustrates a power state while a vehicle according to an exemplary embodiment is driving along a parking path shown in FIG. 3. FIG. 5 illustrates power generation control according to a steering angle and a steering angle speed of a vehicle according to an exemplary embodiment. FIG. 6 illustrates an example of calculating operating power of a vehicle, according to an exemplary embodiment. FIG. 7 is a view illustrating generation control according to a battery charging rate and operating power of a vehicle according to an exemplary embodiment.

As shown in FIG. 2, the vehicle 1 may include an ultrasonic sensor 52, a camera 53, a steering angle sensor 42, a wheel speed sensor 32, a battery sensor 60, and a steering actuator 43, a braking actuator 33, a generator 13, and a controller 100. The ultrasonic sensor 52 may be part of the parking assistance system 50, as described with reference to FIG. 1, and may be electrically connected to the controller 100. For example, the ultrasonic sensor 52 may be directly connected to the controller 100 via a wire harness, or may be connected to the controller 100 via a vehicle communication network NT.

The ultrasonic sensor 52 may be configured to transmit ultrasonic waves in a predetermined direction and receive ultrasonic waves reflected on an object (hereinafter referred to as an “obstacle”) that obstructs the movement of the vehicle 1 such as a wall or an obstacle. The ultrasonic sensor 52 may provide the controller 100 with information regarding the received ultrasonic signal. The camera 53 may be part of the parking assistance system 50 as described in FIG. 1. The camera 53 may be directly connected to the controller 100 or via a vehicle communication network NT. The camera 53 may be configured to capture the outside of the vehicle 1 and generate image data corresponding to the captured image. The camera 53 may provide image data to the controller 100.

The steering angle sensor 42 may be part of the electric steering device 40, as described with reference to FIG. 1, and may be connected directly to the controller 100 or via a vehicle communication network NT. The steering angle sensor 42 may be configured to measure the rotation angle of the steering wheel by the driver's steering operation, and provide steering angle data corresponding to the detected rotation angle to the controller 100. The wheel speed sensor 32 may be part of the electronic brake control module 30 as described with reference to FIG. 1, and may be connected to the controller 100 directly or via a vehicle communication network NT.

The wheel speed sensor 32 may be configured to detect a change in a magnetic field caused by a tone wheel rotating with the wheel. The wheel speed sensor 32 may provide the controller 100 with rotation speed data of the wheel based on the change in the magnetic field. The battery sensor 60 may be configured to detect a charging rate of the battery 62 that stores electrical energy and may be directly connected to the controller 100 or via a vehicle communication network NT. The battery 62 may be configured to store electrical energy generated from power of the engine and supply power to various electrical devices included in the vehicle 1. The generator 13 may be configured to convert rotational energy of the engine into electrical energy while the vehicle 1 is being driven, and the battery 62 may be configured to receive and store electrical energy from the generator 13. If the power consumed by the electrical devices while the vehicle 1 is being driven is greater than the power produced by the generator 13, the battery 62 may be configured to supply power to the electrical loads. In addition, the battery 62 may be configured to supply electric loads to the electric loads while the engine 12 is stopped.

The battery sensor 60 may be configured to measure an output voltage of the battery 62, an output current of the battery 62, and a temperature of the battery 62, and calculate a charging rate of the battery 62 based on the output voltage of the battery 62. Particularly, the charging rate of the battery 62 may represent the degree of storing electrical energy in the battery 62. The charging rate generally has a value of about 0 to 100%, and may indicate the degree to which the battery 62 is charged between the fully discharged state (0%) and the full charge rate (100%). The battery sensor 60 may provide the controller 100 with information regarding the charge rate of the battery 62.

The steering actuator 43 may be part of the electric steering device 40 as described with reference to FIG. 1, and may be connected to the controller 100 directly or via a vehicle communication network NT. The steering actuator 43 may be configured to generate a driving force for changing the direction of the wheel in response to the steering control signal of the controller 100. The driving direction of the vehicle 1 may be changed by the driving force of the steering actuator 43. The braking actuator 33 may be part of the electronic braking control module 30 as described with reference to FIG. 1, and may be connected to the controller 100 directly or via a vehicle communication network NT. The braking actuator 33 may be configured to generate a hydraulic pressure for stopping the rotation of the wheel in response to the braking control signal of the controller 100. Friction occurs between the brake disc and the brake pad by the hydraulic pressure generated by the braking actuator 33, and the rotation of the wheel may be stopped.

The generator 13 may be directly connected to the controller 100 or via a vehicle communication network NT, and may be configured to generate electric energy, that is, electric power, in response to the generation control signal of the controller 100. The engine 12 may be configured to generate power using explosive combustion of fuel, and the power of the engine 12 may be transmitted to the wheel via the transmission 22. At this time, some of the rotational force generated by the engine 12 may be provided to the generator 13, the generator 13 may produce power from the power of the engine 12.

The generator 13 may include, for example, a rotor with a rotor coil (field coil) and a stator with a stator coil (armature coil). The rotor may rotate by rotation of the engine 12 and the stator may be fixed to the engine 12. If a current is supplied to the rotor coil while the rotor is being rotated by the engine 12, a rotating magnetic field is generated, and an induced current is induced to the stator coil due to the rotating magnetic field. Accordingly, the generator 13 may produce electric power. In addition, the magnitude of the magnetic field generated by the rotor changes according to the magnitude of the current supplied to the rotor coil, and the magnitude of the induced current generated in the stator coil may vary. In other words, the power output of the generator 13 may be adjusted according to the magnitude of the current supplied to the coil of the rotor.

Some of the power produced by the generator 13 may be supplied to the electrical devices of the vehicle 1, and the other part may be stored in the battery 62 of the vehicle 1. The controller 100 may include an ECU 51 included in the parking assistance system 50 described with FIG. 1 and/or an ECU 61 included in the power management unit 70. The controller 100 may include a memory 101 configured to a control program and/or control data configured to operate the vehicle 1, and the processor 102 configured to generate a control signal based on a control program and control data stored in the memory 101.

Particularly, the controller 100 may be configured to receive data, signals or information from the ultrasonic sensor 52, the camera 53, the steering angle sensor 42, the wheel speed sensor 32, and the battery sensor 60, and provide a control signal to the generator 13, the steering actuator 43 and the braking actuator 33. For example, the controller 100 may be configured to receive information regarding an ultrasonic signal from the ultrasonic sensor 52 and obtain information regarding an obstacle. Additionally, the processor 101 may be configured to determine the distance and direction to the obstacle based on the phase difference between the transmitting ultrasound and the receiving ultrasound.

The controller 100 may be configured to receive image data from the camera 53 and obtain information regarding an obstacle. For example, the processor 101 may be configured to process image data, thereby detecting an obstacle outside the vehicle 1 and determine a distance and a direction to the obstacle. The controller 100 may be configured to determine a parking space to park the vehicle 1 in based on a distance and a direction to the obstacle, and determine a parking path for parking the vehicle 1 in the parking space. The controller 100 may be configured to operate the steering actuator 43 and the braking actuator 33 for the vehicle 1 to travel along the parking path.

For example, the vehicle 1 may park along the parking path R as shown in FIG. 3. The controller 100 may be configured to operate the steering actuator 43 to change the driving direction of the vehicle 1 at the first position P1 for the vehicle 1 to travel along the parking path R. FIG. The steering actuator 43 may be configured to generate a driving force for changing the direction of the wheel and may consume power to generate the driving force. In other words, the current supplied to the steering actuator 43 may increase rapidly. In addition, after the direction of the wheel is changed, the steering actuator 43 maintains the changed direction of the wheel, and the power consumption of the steering actuator 43 is stopped. In other words, the current supplied to the steering actuator 43 may be drastically reduced.

Such a sudden change in current supply may cause instability in the power system of the vehicle 1. For example, as illustrated in FIG. 4, the current supplied to the steering actuator 43 may increase rapidly at the first time T1 and decrease rapidly at the second time T2. At a first time T1, the vehicle 1 is located at approximately the first position P1, and the controller 100 may be configured to operate the steering actuator 43 to change the direction of the wheel. The steering actuator 43 may be configured to generate a driving force for changing the direction of the wheel and may receive current from the battery 62. Therefore, the driving current supplied to the steering actuator 43 may increase rapidly as shown in FIG. 4.

As the driving current of the steering actuator 43 supplied from the battery 62 increases, the voltage of the battery 62 may decrease. Due to the decrease in the voltage of the battery 62, the generated power of the generator 13 may increase. However, the generated power of the generator 13 increases only after the voltage of the battery 62 becomes unstable, and the increase in the generated power of the generator 13 may be performed after a considerable time has elapsed. Thus, the output voltage of the battery 62 is continuously reduced, which may cause malfunction or reset operation of the electrical devices. Accordingly, instability of the power system of the vehicle 1 may cause malfunction or reset operation of the electrical devices. To prevent this, the controller 100 may be configured to adjust the generated power of the generator 13 based on the expected steering state of the vehicle 1 or the power state or the road state of the vehicle 1.

The controller 100 may be configured to adjust the generated power of the generator 13 based on the expected steering state of the vehicle 1. In particular, the controller 100 may be configured to adjust the generated power of the generator 13 based on the steering angle and/or the steering angle speed. For example, the controller 100 may be configured to determine the steering angle and the steering angle speed at which the vehicle 1 travels along the parking path, and adjust the generated power of the generator 13 based on the determined steering angle and the steering angle speed. As another example, the controller 100 may be configured to receive steering angle data from the steering angle sensor 42 and determine the steering angle and the steering angle speed from the steering angle data. The controller 100 may be configured to adjust the generated power of the generator 13 based on the determined steering angle and the steering angle speed.

Specifically, as shown in FIG. 5, when the steering angle is greater than the reference angle (e.g., about 180 degrees) or when the steering angle speed is greater than the reference angular speed (e.g., about 270 degrees/second), the controller 100 is at the start of steering. It may be possible to increase the generating power of the generator 13 (e.g., prior to the start of steering). Thereafter, the controller 100 may be configured to reduce the generated power of the generator 13 at the end of steering (or before the end of steering). The controller 100 may be configured to adjust the generated power of the generator 13 based on the power state of the vehicle 1. In particular, the controller 100 may be configured to adjust the generated power of the generator 13 based on the available power amount of the vehicle 1 and/or the charge rate of the battery 62.

The available power amount of the vehicle 1 represents the amount of power that the electrical device in the vehicle 1 is capable of consuming in the current generation state of the generator 13 and the current charging rate of the battery 62. For example, as shown in FIG. 6, the controller 100 may be configured to calculate the amount of available power 231 based on the battery maximum power amount 201, the battery charge rate 202, the generator maximum power amount 203, the basic power consumption amount 211 and the convenient load power consumption amount 221.

The controller 100 may be configured to calculate the maximum output power amount 211 based on the sum 210 of the product of the battery maximum power amount 201 and the battery charge rate 202, and the generator maximum power amount 203. The maximum output power amount 211 indicates the amount of power that the battery 62 and the generator 13 may output at maximum. The controller 100 may be configured to calculate the maximum available power amount 221 based on the difference 220 between the maximum output power amount 211 and the basic power consumption amount 212. The basic power consumption 212 represents the amount of power basically consumed by the vehicle 1 for driving (for example, the amount of power for driving, shifting, braking, and steering). The maximum available power amount 221 represents the maximum amount of power that electric devices are capable of consuming in the vehicle 1 being operated.

The controller 100 may be configured to calculate the available power amount 231 based on the difference 230 between the maximum available power amount 221 and the convenient load power consumption amount 222. The convenience load power consumption amount 222 represents the amount of power consumed by the convenience load (for example, air conditioner, heater, audio, etc.) operated under the control of the driver. The available power amount 231 represents the amount of power that the electric devices may consume without causing inconvenience to the driver in the driving vehicle 1. In addition, the controller 100 may be configured to receive information regarding the charge rate of the battery 62 from the battery sensor 60, and determine the charge rate of the battery 62 therefrom.

As shown in FIG. 7, when the available power amount 231 is less than the reference power amount or the battery charge rate 202 is less than the reference power rate, the controller 100 may be configured to increase the generated power of the generator 13 at the start of steering (or before the start of steering). Thereafter, the controller 100 may be configured to reduce the generated power of the generator 13 at the end of steering (or before the end of steering).

The controller 100 may be configured to adjust the generated power of the generator 13 based on the road condition. In particular, the controller 100 may be configured to adjust the generated power of the generator 13 based on the friction coefficient of the road. For example, a road with a large coefficient of friction requires a substantial amount of driving force for steering, thereby increasing the driving current of the steering actuator 43. In addition, a road with a small friction coefficient requires a less driving force for steering, whereby the driving current of the steering actuator 43 may be reduced. Therefore, the controller 100 may be configured to adjust the generated power of the generator 13 on the road having a large friction coefficient.

The controller 100 may be configured to receive the rotation speed data of the wheel from the wheel speed sensor 32 and determine the wheel rotation speed from the rotation speed data. In addition, the controller 100 may be configured to determine the slip ratio of the wheel based on the wheel rotation speed of the wheels, and determine the friction coefficient of the road based on the slip ratio of the wheel. If the friction coefficient of the road is greater than the reference value, during steering, the controller 100 may be configured to increase the generated power of the generator 13 at the start of steering (or before the start of steering). Thereafter, the controller 100 may be configured to reduce the generated power of the generator 13 at the end of steering (or before the end of steering). In addition, when the friction coefficient of the road is less than the reference value, the controller 100 may be configured to maintain the generated power of the generator 13.

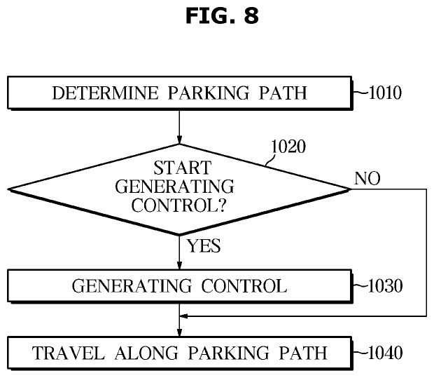

FIG. 8 is a diagram illustrating generation control of a vehicle according to an exemplary embodiment. The method described herein below may be executed by the controller. The vehicle 1 may determine a parking path (1010). The controller 100 may be configured to determine a parking space to park the vehicle 1 based on the output of the ultrasonic sensor 52 and/or the output of the camera 53, and determine the parking path to park the vehicle 1 in the parking space. In addition, the controller 100 may be configured to estimate the steering angle and/or the steering angle speed based on the parking path. The vehicle 1 may be configured to determine whether power generation control is necessary (1020).

The controller 100 may be configured to adjust the generated power of the generator 13 based on the expected steering state of the vehicle 1 or the power state or the road state of the vehicle 1. For example, the controller 100 may be configured to determine whether the steering angle is greater than the reference angle or whether the steering angle speed is greater than the reference angle speed. The controller 100 may be configured to determine whether the available power amount 231 is less than the reference power amount or the battery charge rate 202 is less than the reference charge rate. In addition, the controller 100 may be configured to determine whether the friction coefficient of the road is greater than the reference value.

In response to determining that power generation control is started (YES in 1020), the vehicle 1 may be configured to perform power generation control (1030). In response to determining that the steering angle is greater than the reference angle or the steering angular velocity is greater than the reference angular velocity, the controller 100 may be configured to increase the generated power of the generator 13 at the start of steering (or before the steering starts). Thereafter, the controller 100 may be configured to reduce the generated power of the generator 13 at the end of steering (or before the end of steering). For example, the controller 100 may be configured to increase the generated power of the generator 13 based on the parking path, ahead of the reference steering start time (e.g., about 0.5 seconds). Then, the controller 100 may be configured to reduce the generated power of the generator 13 before the reference time (e.g., about 0.5 seconds) ahead of the expected steering end time based on the parking path.

In response to determining that the available power amount 231 is less than the reference power amount or the battery charge rate 202 is less than the reference charge rate, the controller 100 may be configured to increase the generated power of the generator 13 at the start of steering (or before the start of steering). Thereafter, the controller 100 may be configured to reduce the generated power of the generator 13 at the end of steering (or before the end of steering). In response to determining that the friction coefficient of the road is greater than the reference value, the controller 100 may be configured to increase the generated power of the generator 13 at the start of steering (or before the start of steering). Thereafter, the controller 100 may be configured to reduce the generated power of the generator 13 at the end of steering (or before the end of steering).

In response to determining not to start the power generation control (NO in 1020), the vehicle 1 travels along the parking path (1040). The vehicle 1 may travel along the parking path while performing power generation control (1040). The controller 100 may be configured to operate the steering actuator 43 and the braking actuator 33 so that the vehicle 1 travels along the parking path. Accordingly, by activating the power generation control before the steering start of the vehicle 1, the vehicle 1 may prevent the voltage of the battery 62 from becoming unstable at the time of steering.

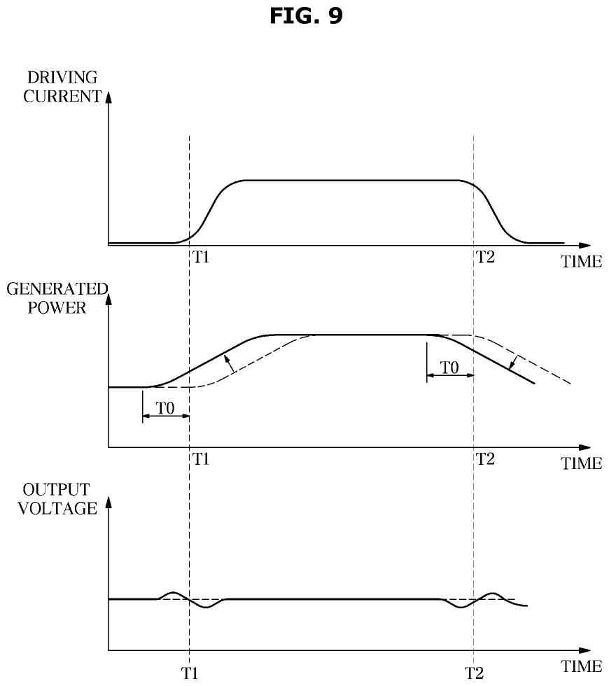

For example, as shown in FIG. 9, if steering start is expected while parking, the vehicle 1 may increase the generated power of the generator 13 ahead of the steering start time T0. Accordingly, the change in the output voltage of the battery 62 at the start of steering may be reduced. In addition, if steering end is expected, the vehicle 1 may reduce the generated power of the generator 13 before the reference end time T0 before the steering end time. Accordingly, the change in the output voltage of the battery 62 at the end of steering may be reduced.

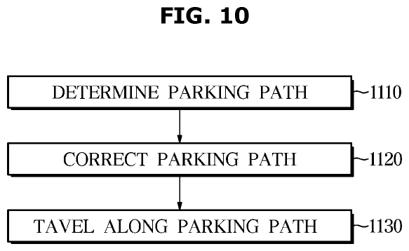

FIG. 10 illustrates a parking path optimization of a vehicle according to an exemplary embodiment. The vehicle 1 may be configured to determine a parking path (1110). Operation 1110 may be the same as operation 1010 illustrated in FIG. 8. The vehicle 1 may be configured to correct the parking path (1120).

The controller 100 may be configured to adjust the generated power of the generator 13 based on the expected steering state of the vehicle 1. For example, the controller 100 may be configured to correct the parking path so that the steering angle is less than the reference angle when the steering angle is greater than the reference angle, and correct the parking path so that the steering angle speed is less than the reference angular speed when the steering angle speed is greater than the reference angular speed.

The vehicle 1 travels along the parking path (1130). Operation 1130 may be the same as operation 1040 illustrated in FIG. 8. Accordingly, by correcting the steering angle of the parking path of the vehicle 1, the vehicle 1 may prevent the voltage of the battery 62 from becoming unstable at the time of steering. On the other hand, the above-mentioned exemplary embodiments may be implemented in the form of a recording medium storing commands capable of being executed by a computer system. The commands may be stored in the form of program code. When the commands are executed by the processor, a program module is generated by the commands so that the operations of the disclosed embodiments may be carried out. The recording medium may be implemented as a non-transitory computer-readable recording medium.

The non-transitory computer-readable recording medium includes all types of recording media storing data readable by a computer system. Examples of the computer-readable recording medium include a Read Only Memory (ROM), a Random Access Memory (RAM), a magnetic tape, a magnetic disk, a flash memory, an optical data storage device, or the like. Although a few exemplary embodiments of the present disclosure have been shown and described, it would be appreciated by those skilled in the art that changes may be made in these exemplary embodiments without departing from the principles and spirit of the disclosure, the scope of which is defined in the claims and their equivalents.

In accordance with an aspect of the present disclosure, it may be possible to provide a vehicle and controlling method thereof allowing temporary driving of a temporary driver for a short time. In accordance with an aspect of the present disclosure, the power supply stability of the vehicle may be ensured. In accordance with an aspect of the present disclosure, it may be possible to provide a vehicle and a control method thereof capable of stably supplying electric power to an electric device.

In accordance with an aspect of the present disclosure, it may be possible to provide a vehicle capable of estimating power consumption of electrical devices during parking and a control method thereof. In accordance with an aspect of the present disclosure, it may be possible to provide a vehicle and a control method thereof capable of adjusting the amount of power generated by a generator based on an estimated power consumption during parking. In accordance with an aspect of the present disclosure, it may be possible to provide a vehicle and a control method thereof capable of stably supplying electric power to a powered provision device while parking.

In accordance with an aspect of the present disclosure, it may be possible to provide a vehicle and a control method thereof capable of stably supplying electric power without adding parts. In accordance with an aspect of the present disclosure, it may be possible to provide a vehicle and a control method thereof capable of stably supplying electric power without increasing the revolution per minute (RPM) of the engine.

### DESCRIPTION OF SYMBOLS

1: vehicle
10: engine management system
12: engine
13: generator
20: transmission controller
22: transmission
30: electronic brake control module
32: wheel speed sensor
33: braking actuator
40: electric steering device
42: steering angle sensor
43: steering actuator
50: parking assistance system
52: ultrasonic sensor
53: camera
60: battery sensor
62: battery
70: power management unit
100: controller

What is claimed is:

1. A vehicle, comprising:
an electric steering device configured to change a driving direction of the vehicle;
a battery configured to supply power to the electric steering device;
a generator configured to supply power to at least one of the electric steering device and the battery; and
a controller configured to determine at least one of a steering angle and a steering angle speed of the electric steering device based on the driving path of the vehicle, and adjust the generated power of the generator before operating the electric steering device based on at least one of the steering angle and the steering angle speed.

2. The vehicle according to claim 1, wherein the controller is configured to increase the generated power of the generator before operating the electric steering device when the steering angle is greater than a predetermined angle or the steering angle speed is greater than a predetermined angular speed.

3. The vehicle according to claim 2, wherein the controller is configured to decrease the generated power of the generator before terminating the operation of the electric steering device.

4. The vehicle according to claim 1, wherein the controller is configured to adjust the generated power of the generator before operating the electric steering device based on at least one of an available power of the vehicle and a charge rate of the battery.

5. The vehicle according to claim 4, wherein the controller is configured to increase the generated power of the generator before operating the electric steering device in response to determining that the available power of the vehicle is less than a reference power or the chare rate of the battery is less than a reference charge rate.

6. The vehicle according to claim 1, wherein the controller is configured to adjust the generated power of the generator before operating the electric steering device based on a friction coefficient of a road on which the vehicle is being driven.

7. The vehicle according to claim 6, wherein the controller is configured to increase the generated power of the generator before operating the electric steering device when the friction coefficient is greater than a reference value.

8. The vehicle according to claim 1, wherein the controller is configured to correct the driving path when the steering angle is greater than a reference angle or the steering angular speed is greater than the a reference angle speed.

9. The vehicle according to claim 8, wherein the controller is configured to correct the driving path to adjust the steering angle to be less than the reference angle or the steering angle speed to be less than the reference angular speed.

10. The vehicle according to claim 1, wherein the controller is configured to generate a parking path to park the vehicle, determine at least one of the steering angle or the steering angle speed of the electric steering device, and adjust the generated power of the generator based on at least one of the steering angle or the steering angle speed.

11. A method for controlling a vehicle including an electric steering device, a battery and a generator, comprising:
determining, by a controller, a driving path of the vehicle;
determining, by the controller, a steering angle and a steering angle speed of the electric steering device based on the driving path;
adjusting, by the controller, a generated power of the generator before operating the electric steering device based on at least one of the steering angle and the steering angle speed.

12. The method according to claim 11, wherein adjusting the generated power of the generator includes: increasing, by the controller, the generated power of the generator before operating the electric steering device when the steering angle is greater than a predetermined angle or the steering angle speed is greater than a predetermined angular speed.

13. The method according to claim 12, wherein adjusting the generated power of the generator includes: decreasing, by the controller, the generated power of the generator before terminating the operation of the electric steering device.

14. The method according to claim 11, further comprising:
adjusting, by the controller, the generated power of the generator before operating the electric steering device based on at least one of an available power of the vehicle and a charge rate of the battery.

15. The method according to claim 14, wherein adjusting the generated power of the generator based on at least one of the available power of the vehicle and the charge rate of the battery includes: increasing, by the controller, the generated power of the generator before operating the electric steering device when the available power of the vehicle is less than a reference power or the charge rate of the battery is less than a reference charge rate.

16. The method according to claim 15, further comprising:
adjusting, by the controller, the generated power of the generator before operating the electric steering device based on a friction coefficient of a road on which the vehicle is being driven.

17. The method according to claim 16, wherein adjusting the generated power of the generator based on the friction coefficient of the road includes: increasing, by the controller, the generated power of the generator before operating the electric steering device when the friction coefficient is greater than a reference value.

18. The method according to claim 17, the method further includes: correcting, by the controller, the driving path in response to determining that the steering angle is greater than a reference angle or the steering angular speed is greater than the reference angle speed.

19. The method according to claim 18, wherein correcting the driving path includes:
correcting, by the controller, the driving path to adjust the steering angle to be less than the reference angle or the steering angle speed to be less than the reference angular speed.

20. The method according to claim 11, further comprising:
generating, by the controller, a parking path to park the vehicle,
determining, by the controller, at least one of the steering angle or the steering angle speed of the electric steering device, and
adjusting, by the controller, the generated power of the generator based on at least one of the steering angle or the steering angle speed.
